(19) United States
(12) Patent Application Publication
(10) Pub. No.: US 2024/0184973 A1
(43) Pub. Date: Jun. 6, 2024

(54) METHOD AND APPARATUS FOR GENERATING DOCUMENT TAG, AND TERMINAL AND STORAGE MEDIUM

(71) Applicant: BEIJING ZITIAO NETWORK TECHNOLOGY CO., LTD., Beijing (CN)

(72) Inventors: Angeline Lim Sze YUIN, Beijing (CN); Yuzhen CAI, Beijing (CN)

(21) Appl. No.: 18/279,378

(22) PCT Filed: Mar. 1, 2022
(86) PCT No.: PCT/CN2022/078560

§ 371 Date: Aug. 29, 2023

(30) Foreign Application Priority Data
Mar. 1, 2021 (CN) 202110226955.9

(51) Int. Cl. G06F 40/117

(52) U.S. Cl. CPC G06F 40/117

(57) ABSTRACT

Provided in the present disclosure are a method and apparatus for generating a document tag, and a terminal and a storage medium. The method for generating a document tag comprises: on the basis of the content of a first document, providing a candidate tag for the first document; and in response to a first preset operation on the candidate tag, generating a tag corresponding to the first document, wherein the tag is associated with a second document, and the second document comprises document content, which corresponds to the tag, in the first document. Tag clustering is performed in the second document associated with the tag, and document content corresponding to the tag can be viewed in the second document, thereby realizing the effects of automatic classification and sorting assistance, improving the aggregation of knowledge graphs, and improving the value of such a document structure.

### CROSS REFERENCE TO RELATED APPLICATIONS

The present application is based upon and claims priority to Chinese Patent Application No. 202110226955.9, filed on Mar. 1, 2021 and entitled “METHOD AND APPARATUS FOR GENERATING DOCUMENT TAG, AND TERMINAL AND STORAGE MEDIUM”, the entire contents of which are incorporated herein by reference.

### TECHNICAL FIELD

The present disclosure relates to the field of information technology, in particular to a document tag generating method and apparatus, a terminal, and a storage medium.

### BACKGROUND

In a process of reading or editing a document, some keywords may appear to classify and organize document content, but keyword information (tags) cannot be provided in the process of editing the current document. In addition, the tags are only custom field values and cannot be expanded in any way to serve more different application scenarios.

Moreover, if a user classifies and organizes documents, scattering, inconsistency, and overlapping often occur. The current classification and organization of tags can only be used for search and filtering, with relatively single functions.

### SUMMARY

To solve the existing problems, the present disclosure provides an information processing method and apparatus, a terminal and a storage medium.

The following technical solutions are adopted in the disclosure.

An embodiment of the present disclosure provides a document tag generating method, the generating method comprises: providing a candidate tag for a first document based on content of the first document; and generating a tag corresponding to the first document in response to a first preset operation on the candidate tag, wherein the tag is associated with a second document, and the second document comprises document content corresponding to the tag in the first document.

Another embodiment of the present disclosure provides a document tag generating apparatus, the generating apparatus comprises: a candidate tag providing module configured to provide a candidate tag for a first document based on content of the first document; and a tag generating module configured to generate a tag corresponding to the first document in response to a first preset operation on the candidate tag, wherein the tag is associated with a second document, and the second document comprises document content corresponding to the tag in the first document.

Some embodiments of the present disclosure provide a terminal, the terminal comprising: at least one memory and at least one processor; wherein the memory is configured to store program code, and the processor is configured to call the program code stored by the memory to perform the above document tag generating method.

Some embodiments of the present disclosure provide a storage medium for storing program code, wherein the program code, when executed by a processor, cause the processor to perform the above document tag generating method.

In some embodiments of the present disclosure, the tag is associated with the second document which includes document content corresponding to the tag in the first document, whereby tag clustering is performed in the second document associated with the tag, and the document content corresponding to the tag may be viewed in the second document, thereby achieving effects of automatic classification and auxiliary organization, improving aggregation of knowledge graphs, and enhancing the value of this document structure.

### BRIEF DESCRIPTION OF THE DRAWINGS

These and other features, advantages and aspects of embodiments of the present disclosure will become more apparent in conjunction with the drawings and with reference to the following specific embodiments. Throughout the drawings, identical or similar appended marks indicate identical or similar elements. It should be understood that the drawings are schematic and that the elements and components are not necessarily drawn to scale.

FIG. 1 is a flowchart of a document tag generating method according to an embodiment of the present disclosure.

FIG. 2A and FIG. 2B illustrate schematic diagrams of a second document corresponding to a tag according to some embodiments of the present disclosure.

FIG. 3 illustrates some modules of a document tag generating apparatus according to another embodiment of the present disclosure.

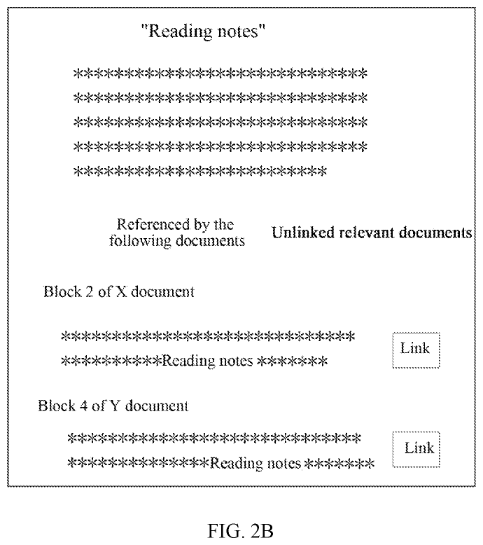

FIG. 4 is a schematic structural diagram of an electronic device according to an embodiment of the present disclosure.

### DETAILED DESCRIPTION OF PREFERRED EMBODIMENTS

Embodiments of the present disclosure will be described in greater detail below with reference to the drawings. While certain embodiments of the present disclosure are shown in the drawings, it should be understood that the present disclosure may be implemented in various forms and should not be construed as being limited to the embodiments set forth herein, but instead are provided for a more thorough and complete understanding of the present disclosure. It should be understood that the drawings and embodiments of the present disclosure are for exemplary purposes only and are not intended to limit the scope of protection of the present disclosure.

It should be understood that the steps documented in the device embodiments of the present disclosure may be performed in a different order, and/or in parallel. In addition, the device embodiments may include additional steps and/or omit to perform the steps shown. The scope of the present disclosure is not limited in this regard.

The term “includes” and variations thereof as used herein are open-ended, i.e., “includes but is not limited to”. The term “based on” is “based, at least in part, on”. The term “an embodiment” means “at least one embodiment”; the term “another embodiment” means “at least one additional embodiment”; the term “some embodiment” indicates “at least some embodiments”. Related definitions of other terms will be given in the description below.

It should be noted that the concepts of “first” and “second” mentioned in this disclosure are used only to distinguish between different devices, modules or units, and are not intended to define the order or interdependence of the functions performed by these devices, modules or units.

It should be noted that the modifications of “one” referred to in this disclosure are illustrative rather than limiting, and it should be understood by those skilled in the art to mean “one or more” unless the context clearly indicates otherwise.

The names of the messages or information interacted between the plurality of devices in this implementation of the disclosure are used for illustrative purposes only and are not intended to limit the scope of those messages or information. In the embodiments of the present disclosure, documents may include but are not limited to online documents.

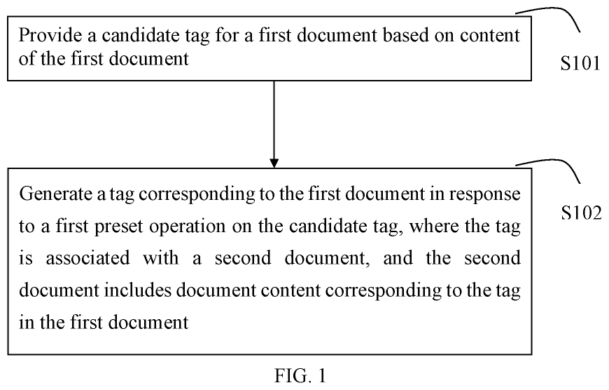

As shown in FIG. 1, an embodiment of the present disclosure provides a flowchart of a document tag generating method. The document tag generating method of the present disclosure may include:

Step S101: Provide a candidate tag for a first document based on content of the first document. In some embodiments, during or after editing the document, or during reading the first document, a user may recommend the candidate tag for the first document based on the content of the first document. In the embodiments of the present disclosure, the tag refers to a keyword used for indicating content that may be involved in the document. In some embodiments, the candidate tag of the present disclosure is selected by the user. In some embodiments, the candidate tag may be provided for the first document either in the editing process of the first document or after the first document has been edited (for example, when the first document is read).

In some embodiments, the document tag generating method of the present disclosure may further include:

Step S102: Generate a tag corresponding to the first document in response to a first preset operation on the candidate tag. In some embodiments, the first preset operation includes a click operation, a voice instruction, or the like. In some embodiments, one or more candidate tags may be provided. For example, after candidate tags are provided for the first document, if the user clicks one of the candidate tags, it is considered that the clicked candidate tag is to be used, that is, a tag corresponding to the first document is generated.

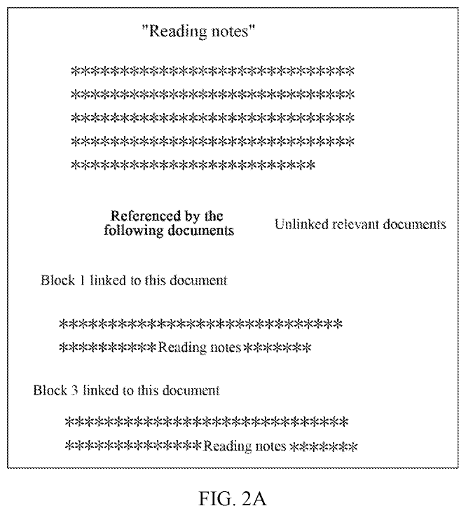

In some embodiments, the tag is associated with a second document, which includes specific content corresponding to the tag. Unlike usual keywords or tags of documents, the tag of the present disclosure may be associated with a second document or may be considered as corresponding to a link to the second document. The second document may display content block (or block) content corresponding to the tag in the first document, and the position where the tag appears in the block content may be highlighted. It should be understood that a document may be composed of corresponding content blocks (or blocks), which are a part of the document and may carry a plurality of data types. It may be considered that a document is composed of one or more content blocks. As shown in FIG. 2A, the second document includes a document using the tag and corresponding content, and may indicate which block of the document the tag appears in. In this way, tag clustering is performed in the second document associated with the tag, and the document content corresponding to the tag may be viewed in the second document, thereby achieving effects of automatic classification and auxiliary organization, improving aggregation of knowledge graphs, and enhancing the value of this document structure.

In some embodiments, providing the candidate tag for the first document based on content of the first document includes: extracting a keyword from the content, and providing the candidate tag for the first document based on the extracted keyword or a network keyword related to the extracted keyword. In some embodiments, the document keyword is extracted by using a keyword algorithm capability of artificial intelligence (AI). In some embodiments, external entity words may be used for segmentation filtering and recommended to the user as candidate tags. The external entity words refer to public keywords generally in Baidu Baike and Wikipedia. The segmented content is matched with these public terms and filtered, which can greatly improve accuracy of recommended candidate tags for different types of document content to cover different scenarios.

In some embodiments, providing the candidate tag for the first document based on content of the first document includes: providing the candidate tag for the first document based on a tag of a third document when the first document references the third document. In some embodiments, referencing the third document may refer to presenting the third document in the second document in any suitable form such as link/preview. If the third document is referenced and has been tagged, the tag of the third document may also be recommended as the candidate tag for the first document. In this way, the scope of recommended candidate tags is expanded. In addition, the correlation between the first document and the referenced third document is enhanced, and the network of tag clustering is expanded.

In some embodiments, providing the candidate tag for the first document based on content of the first document includes: providing the candidate tag for the first document based on a tag of a fourth document corresponding to a content block of the fourth document when the first document references the content block of the fourth document. If the content block of the fourth document is referenced and the content of the content block of the fourth document has tags marked in the fourth document, these tags of the fourth document may also be recommended as candidate tags for the first document. In this way, the scope of recommended candidate tags is expanded. In addition, the correlation between the first document and the referenced content block of the fourth document is enhanced, and the network of tag clustering is expanded.

In some embodiments, a title of the second document is the tag, or content of the second document is the tag. For example, as shown in FIG. 2A, the tag of the first document is assumed as “Reading notes”, and the title displayed in the second document is “Reading notes”. In some embodiments, the content of the second document is the content of the tag. In this way, the association between the tag and the second document can be better reflected, and the corresponding tag can be seen when entering the second document.

In some embodiments, the tag is associated with the second document includes: creating, based on the tag, the second document associated with the tag in the absence of the second document. That is, an associated second document may be created for a new tag. In some embodiments, an association relationship between the tag and the second document is created in the presence of the second document. For example, when the tag has been used in other documents, if the tag is used in the first document, the tag may be directly reused, the second document associated with the tag may also be used accordingly, and the association relationship between the tag and the second document is established, so that the tag is associated with the existing second document. This also improves the efficiency of generating a tag and creating a second document associated with the tag.

In some embodiments, the document tag generating method of the present disclosure may further include: displaying document content of the second document in response to a second preset operation on the tag. In some embodiments, the second preset operation may include a click operation, a voice instruction, or the like. For example, the tag is clicked to open the second document associated with the tag, thereby displaying the document content of the second document. This enhances the association between the tag and the second document and facilitates user's viewing.

In some embodiments, the second document may further include information of a fifth document corresponding to the tag. In some embodiments, some other documents also include the content of the tag, but may not adopt the tag. In the second document, document information that corresponds to the tag but does not adopt the tag may be listed separately, which facilitates user's reference and expands the knowledge graph of the tag. FIG. 2B shows a plurality of fifth documents (for example, X document and Y document) that include the content of the tag but do not adopt the tag.

In some embodiments, the fifth document includes a document that has adopted the tag and/or a document that has not adopted the tag. In some embodiments, content of the document that has not adopted the tag includes document content corresponding to the tag.

In some embodiments, when the third document does not adopt the tag, the third document is enabled to adopt the tag of the first document in response to a third preset operation on a preset button displayed in the second document. In some embodiments, the third preset operation may include a click operation, a voice instruction, or the like. FIG. 2B shows the preset button “Link”. It should be understood that this is only exemplary and other suitable buttons may be used. For example, the button “Link” is clicked to enable the third document to adopt the tag, that is, add the tag to a location where the tag is placed in the third document. In this way, the tag of the third document is processed in the second document, thereby greatly facilitating management and operation of documents.

In some embodiments, when the fifth document has adopted the tag, a title of the fifth document and document content of a content block of the fifth document where the tag is located are displayed at a preset position in the second document. Refer to FIG. 2A, which shows the content block where the tag of the first document is located and the corresponding document content. Similarly, when the fifth document has adopted the tag, the content of the fifth document may be displayed in a form of a list at a preset position in the second document (for example, displayed below the content block of the first document where the tag is located), for example, displayed in a form of a list at a position below following the content block of the first document where the tag is located. The displayed content may include the title of the fifth document and the document content of the content block of the fifth document where the tag is located, and the position where the tag appears may be highlighted.

An embodiment of the present disclosure further provides a document tag generating apparatus 300. The document tag generating apparatus 300 includes a candidate tag providing module 301 and a tag generating module 302. In some embodiments, the candidate tag providing module 301 is configured to provide a candidate tag for a first document based on content of the first document. In some embodiments, the tag generating module 302 is configured to generate a tag corresponding to the first document in response to a first preset operation on the candidate tag, where the tag is associated with a second document, and the second document includes document content corresponding to the tag in the first document.

It should be understood that the description of the document tag generating method also applies to the document tag generating apparatus 300 here. For simplicity, a detailed description will not be provided here.

In some embodiments, the providing a candidate tag for a first document based on content of the first document includes: extracting a keyword from the content; and providing the candidate tag for the first document based on the extracted keyword or a network keyword related to the extracted keyword. In some embodiments, the providing a candidate tag for a first document based on content of the first document includes: providing the candidate tag for the first document based on a tag of a third document when the first document references the third document. In some embodiments, the providing a candidate tag for a first document based on content of the first document includes: providing the candidate tag for the first document based on a tag of a fourth document corresponding to a content block of the fourth document when the first document references the content block of the fourth document. In some embodiments, a title of the second document is the tag, or content of the second document is the tag. In some embodiments, the association between the tag and the second document includes: creating, based on the tag, the second document associated with the tag in the absence of the second document; or creating an association relationship between the tag and the second document in the presence of the second document In some embodiments, the generating apparatus further includes a tag document display module, configured to display document content of the second document in response to a second preset operation on the tag. In some embodiments, the second document further includes information of a fifth document corresponding to the tag. In some embodiments, the fifth document includes a document that has adopted the tag and/or a document that has not adopted the tag, where content of the document that has not adopted the tag includes document content corresponding to the tag. In some embodiments, when the fifth document has not adopted the tag, the fifth document is enabled to adopt the tag in response to a third preset operation on a preset button displayed in the second document. In some embodiments, when the fifth document has adopted the tag, a title of the fifth document and document content of a content block of the fifth document where the tag is located are displayed at a preset position in the second document.

In addition, the present disclosure further provides a terminal, including: at least one memory and at least one processor, where the memory is configured to store program code, and the processor is configured to call the program code stored in the memory to perform the foregoing document tag generating method.

Moreover, the present disclosure further provides a computer storage medium, the computer storage medium storing program code, and the program code being used for performing the foregoing document tag generating method.

The document tag generating method and apparatus of the present disclosure are described above based on embodiments and application examples. In addition, the present disclosure further provides a terminal and a storage medium, which are described below.

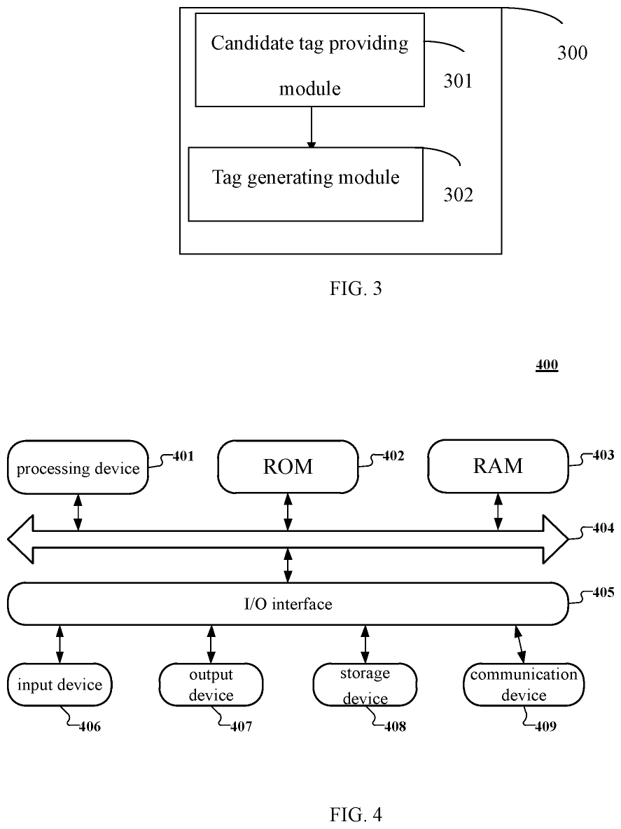

Referring to FIG. 4 below, a schematic structural diagram of an electronic device 400 suitable for being used to realize the embodiments of the present disclosure is illustrated. Terminal devices in the embodiments of the present disclosure may include, but are not limited to, mobile terminals such as mobile phones, notebook computers, digital broadcast receivers, personal digital assistants (PDAs), PADs, portable multimedia players (PMPs) and vehicle-mounted terminals (for example, vehicle-mounted navigation terminals), and fixed terminals such as digital TVs and desktop computers. The electronic device shown in FIG. 4 is only an example, and should not bring any limitation to the functions and the scope of use of the embodiments of the present disclosure.

As shown in FIG. 4, the electronic device 400 may include a processing device (e.g., a central processor, a graphics processor, etc.) 401 that may perform a variety of suitable actions and processes in accordance with a program stored in a read-only memory (ROM) 402 or a program loaded from a storage device 408 into a random access memory (RAM) 403. In the RAM 403, various programs and data required for the operation of the electronic device 400 are also stored. The processing device 401, the ROM 402 and the RAM 403 are connected to each other via a bus 404. An input/output (I/O) interface 405 is also connected to the bus 404.

In general, the following devices may be connected to the I/O interface 405: an input device 406 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, magnetic tape, hard disk, etc.; and a communication device 409. The communication device 409 may allow the electronic device 400 to communicate in a wireless or wired manner with other devices to exchange data. Although FIG. 4 illustrates a electronic device 400 having a variety of devices, it should be understood that not all illustrated devices are required to be implemented or provided. More or fewer devices may alternatively be implemented or provided.

Particularly, in accordance with embodiments of the present disclosure, the processes described above with reference to the flowcharts may be implemented as computer software programs. For example, embodiments of the present disclosure include a computer program product comprising a computer program carried on a computer-readable medium, the computer program containing program code for performing the methods shown in the flowchart. In such an embodiment, the computer program may be downloaded and installed from the network via the communication device 409, or installed from the storage device 408, or installed from the ROM 402. When the computer program is executed by the processing device 401, the above-mentioned functions defined in the method of the embodiments of the present disclosure are performed.

It should be noted that the computer storage media described in embodiments of the present disclosure may be computer readable signal media or computer readable storage media or any combination of the two. The computer-readable storage medium may be, for example but not limited to, an electrical, magnetic, optical, electromagnetic, infrared, or semiconductor system, apparatus, or device, or any combination thereof. More specific examples of computer-readable storage media may include, but are not limited to: an electrical connection having one or more wires, a portable computer diskette, a hard disk, a random access memory (RAM), a read only memory (ROM), an erasable programmable read-only memory (EPROM) or flash memory (FLASH), an optical fiber, a compact disc read-only memory (CD-ROM), an optical storage device, a magnetic storage device, or any suitable combination thereof. In the present disclosure, a computer-readable storage medium can be any tangible medium that can contain or store a program for use by or in connection with an instruction execution system, apparatus, or device. In the present disclosure, a computer-readable signal medium may include a data signal that propagates in baseband or as part of a carrier wave, carrying computer-readable program code. Such propagated data signals may take many forms, including but not limited to electromagnetic signals, optical signals, or any suitable combination thereof. The computer-readable signal medium may also be any computer-readable medium other than the computer-readable storage medium that can transmit, propagate, or transport the program for use by or in connection with the instruction execution system, apparatus, or device. The program code embodied on the computer-readable medium may be transmitted using any suitable medium including, but not limited to: wire, fiber optic cable, radio frequency (RF), and the like, or any suitable combination thereof.

In some embodiments, the client and server can communicate with any currently known or future-developed network protocol such as HTTP (HyperText Transfer Protocol), and can communicate (for example, by communication network) with digital data in any form or medium. Examples of communication networks include local area networks (“LAN”), wide area networks (“WAN”), the Internet (for example, the Internet), and end-to-end networks (for example, ad hoc end-to-end networks), as well as any currently known or future-developed network.

The computer-readable medium can be contained in the electronic device; it may also be separate and not assembled into the electronic device.

The storage medium carries one or more program, wherein the program, when executed by a processor, cause the processor to perform the above method of the present disclosure.

Computer program code for carrying out operations of the present disclosure may be written in one or more programming languages, including object-oriented programming languages such as Java, Smalltalk, C++, and conventional procedural programming languages such as the “C” language or similar programming languages. The program code may execute entirely on the user's computer, partially on the user's computer, as a stand-alone software package, partially on the user's computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., through the Internet using an Internet service provider).

The flowcharts and block diagrams in the drawings illustrate the architecture, functionality, and operation of possible implementations of systems, methods, and computer program products in accordance with various embodiments of the present disclosure. In this regard, each block of the flowcharts or block diagrams may represent a module, segment, or portion of code, which comprises one or more executable instructions for implementing the specified logical function (s). It should also be noted that in some alternative implementations, the functions noted in the blocks may occur out of the order noted in the figures. For example, two blocks shown in succession may, in fact, be executed substantially concurrently or they may sometimes be executed in the reverse order, depending upon the functionality involved. It is also noted that each block of the block diagrams and/or flowchart illustrations, and combinations of blocks in the block diagrams and/or flowchart illustrations, can be implemented by special purpose hardware-based systems which perform the specified functions or operations, or combinations of special purpose hardware and computer instructions.

The units described in the embodiments of the present disclosure may be implemented in software or in hardware. Among them, the names of these units do not constitute a limitation on the unit itself under certain circumstances.

The functions described hereinabove may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, equipment, or device, or any suitable combination of the foregoing. More specific examples of machine-readable storage media may include electrical connections based on one or more wires, portable computer disks, hard drives, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a document tag generating method is provided, the generating method comprises: providing a candidate tag for a first document based on content of the first document; and generating a tag corresponding to the first document in response to a first preset operation on the candidate tag, wherein the tag is associated with a second document, and the second document comprises document content corresponding to the tag in the first document.

According to one or more embodiments of the present disclosure, providing the candidate tag for the first document based on content of the first document comprises: extracting a keyword from the content; and providing the candidate tag for the first document based on the extracted keyword or a network keyword related to the extracted keyword.

According to one or more embodiments of the present disclosure, providing the candidate tag for the first document based on content of the first document comprises: providing the candidate tag for the first document based on a tag of a third document when the first document references the third document.

According to one or more embodiments of the present disclosure, providing the candidate tag for the first document based on content of the first document comprises: providing the candidate tag for the first document based on a tag of a fourth document corresponding to a content block of the fourth document when the first document references the content block of the fourth document.

According to one or more embodiments of the present disclosure, a title of the second document is the tag, or content of the second document is the tag.

According to one or more embodiments of the present disclosure, the tag is associated with the second document comprises: creating, based on the tag, the second document associated with the tag in the absence of the second document; or creating an association relationship between the tag and the second document in the presence of the second document.

According to one or more embodiments of the present disclosure, the document tag generating method further comprises: displaying document content of the second document in response to a second preset operation on the tag.

According to one or more embodiments of the present disclosure, the second document further comprises information of a fifth document corresponding to the tag.

According to one or more embodiments of the present disclosure, the fifth document comprises a document that has adopted the tag and/or a document that has not adopted the tag, wherein content of the document that has not adopted the tag comprises document content corresponding to the tag.

According to one or more embodiments of the present disclosure, when the fifth document has not adopted the tag, the fifth document is enabled to adopt the tag in response to a third preset operation on a preset button displayed in the second document.

According to one or more embodiments of the present disclosure, when the fifth document has adopted the tag, a title of the fifth document and document content of a content block of the fifth document where the tag is located are displayed at a preset position in the second document.

According to one or more embodiments of the present disclosure, a document tag generating apparatus is provided, the generating apparatus comprises: a candidate tag providing module configured to provide a candidate tag for a first document based on content of the first document; and a tag generating module configured to generate a tag corresponding to the first document in response to a first preset operation on the candidate tag, wherein the tag is associated with a second document, and the second document comprises document content corresponding to the tag in the first document.

According to one or more embodiments of the present disclosure, a terminal is provided, the terminal comprises: at least one memory and at least one processor; wherein the at least one memory is configured to store program code, and the at least one processor is configured to call the program code stored by the at least one memory to perform the above method.

According to one or more embodiments of the present disclosure, a storage medium for storing program code is provided, the program code, when executed by a processor, cause the processor to perform the above method.

The above description is only a preferred embodiment of the present disclosure and an explanation of the applied technical principles. Those skilled in the art should understand that the scope of disclosure involved in this disclosure is not limited to the technical solutions formed by the specific combination of the above technical features, and should also cover other combinations formed by the above technical features or their equivalent features. Technical solutions. For example, the above-mentioned features and the technical features disclosed in the present disclosure (but not limited to) having similar functions are replaced with each other to form a technical solution.

In addition, although the operations are depicted in a specific order, this should not be understood as requiring these operations to be performed in the specific order shown or performed in a sequential order. Under certain circumstances, multi-task and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. A document tag generating method, the generating method comprising:
providing a candidate tag for a first document based on content of the first document; and
generating a tag corresponding to the first document in response to a first preset operation on the candidate tag,
wherein the tag is associated with a second document, and the second document comprises document content corresponding to the tag in the first document.

2. The document tag generating method according to claim 1, wherein providing the candidate tag for the first document based on content of the first document comprises:
extracting a keyword from the content; and
providing the candidate tag for the first document based on the extracted keyword or a network keyword related to the extracted keyword.

3. The document tag generating method according to claim 1, wherein providing the candidate tag for the first document based on content of the first document comprises:
providing the candidate tag for the first document based on a tag of a third document when the first document references the third document.

4. The document tag generating method according to claim 1, wherein providing the candidate tag for the first document based on content of the first document comprises:
providing the candidate tag for the first document based on a tag of a fourth document corresponding to a content block of the fourth document when the first document references the content block of the fourth document.

5. The document tag generating method according to claim 1, wherein a title of the second document is the tag, or content of the second document is the tag.

6. The document tag generating method according to claim 1, wherein the tag is associated with the second document comprises:
creating, based on the tag, the second document associated with the tag in the absence of the second document; or
creating an association relationship between the tag and the second document in the presence of the second document.

7. The document tag generating method according to claim 1, further comprising:
displaying document content of the second document in response to a second preset operation on the tag.

8. The document tag generating method according to claim 1, wherein the second document further comprises information of a fifth document corresponding to the tag.

9. The document tag generating method according to claim 8, wherein the fifth document comprises a document that has adopted the tag and/or a document that has not adopted the tag, wherein content of the document that has not adopted the tag comprises document content corresponding to the tag.

10. The document tag generating method according to claim 9, wherein when the fifth document has not adopted the tag, the fifth document is enabled to adopt the tag in response to a third preset operation on a preset button displayed in the second document.

11. The document tag generating method according to claim 9, wherein when the fifth document has adopted the tag, a title of the fifth document and document content of a content block of the fifth document where the tag is located are displayed at a preset position in the second document.

12. (canceled)

13. A terminal device, comprising:
at least one memory and at least one processor,
wherein the at least one memory is configured to store program code, and the at least one processor is configured to call the program code stored in the at least one memory to perform operations comprising:
providing a candidate tag for a first document based on content of the first document; and
generating a tag corresponding to the first document in response to a first preset operation on the candidate tag,
wherein the tag is associated with a second document, and the second document comprises document content corresponding to the tag in the first document.

14. A non-transitory computer-readable storage medium for storing program code, and the program code, when executed by a processor, cause the processor to perform operations comprising:
providing a candidate tag for a first document based on content of the first document; and
generating a tag corresponding to the first document in response to a first preset operation on the candidate tag,
wherein the tag is associated with a second document, and the second document comprises document content corresponding to the tag in the first document.
